(19) United States
(12) Patent Application Publication
(10) Pub. No.: US 2016/0055771 A1
(43) Pub. Date: Feb. 25, 2016

(54) LEATHER AWARENESS DEVICE

(71) Applicant: William Snyder, JR., Great Falls, MT (US)

(72) Inventor: William Snyder, JR., Great Falls, MT (US)

(21) Appl. No.: 14/465,935

(22) Filed: Aug. 22, 2014

(51) Int. Cl. G09F 3/02; G09F 3/08

(52) U.S. Cl. CPC G09F 3/02; G09F 3/08; G09F 2003/0208

(57) ABSTRACT

An awareness device to display support for a cause comprising a looped structure, where the looped structure extends between a loop and a pair of ends, and where the looped structure is made from colored leather; a display portion on a first end of the pair of ends, where the display portion represents a cause symbolized by the looped structure; and a fastener attached to the loop, where the fastener enables removable attachment of the looped structure from an object. The awareness device enables a user to display the causes they support on a uniquely crafted awareness tool.

### BACKGROUND OF THE INVENTION

1. Field of the Invention

The present invention relates to an awareness ribbon made of leather that attaches to a keychain to be a continuous reminder of the cause for which the ribbon supports.

2. Description of Related Art

Awareness ribbons are a unique way for people to demonstrate their affiliations with a cause. Each ribbon displays a specific color to represent the group they support. For example, a red ribbon represents heart disease, so a supporter of heart disease research may wear a red ribbon to show their support. A pink ribbon represents breast cancer, so supporters, survivors and family members wear this ribbon proudly in support. Similarly, multiple colors or a pattern of colors may be used for representation. For example, a pink and blue ribbon reflects pro-life support, so people wearing this ribbon demonstrate their support of pro-life causes. Often the same color represents two or more groups or causes. Thus, the same red ribbon worn by the heart disease wearer may also reflect AIDS support. The wearer may have to explain or distinguish which cause they support when asked about the color. Some ribbons include sayings to specify which causes the color reflects. For example, a yellow ribbon may represent armed forces return, spina bifida awareness, bone cancer, suicide prevention and multiple other causes. For distinction SUPPORT OUR TROOPS may be written on the ribbon to distinguish support for the armed forces from the other causes. Most of the time the ribbons are not labeled or marked so confusion is inherent.

Because of all the confusion with colors, it would be beneficial in the art to provide a support device that allows the user to customize their affiliation. It would also be desirable in the art to provide a support device that allows display in a location of the wearers choosing, without requiring adornment on the clothes.

### SUMMARY OF THE INVENTION

In view of the foregoing disadvantages inherent in the prior art, the general purpose of the present invention is to provide an awareness device to display support for a cause, configured to include all of the advantages of the prior art, and to overcome the drawbacks inherent therein. Accordingly, an object of the present invention is to provide a leather awareness device embodied as a leather awareness ribbon to show support for a cause.

Another object of the present invention is to provide a leather awareness device with a display portion, where the display portion identifies the cause for which the device represents.

Yet another object of the present invention is to provide a leather awareness device with a fastener to enable attachment on an object of the user's choosing.

To achieve the above objects, in an aspect of the present invention, an awareness device is described comprising a looped structure, where the looped structure extends between a loop and a pair of ends, and where the looped structure is made from colored leather; a display portion on a first end of the pair of ends, where the display portion represents a cause symbolized by the looped structure; and a fastener attached to the loop, where the fastener enables removable attachment of the looped structure from an object. The awareness device enables a user to display the causes they support on a uniquely crafted awareness tool.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWING

The advantages and features of the present invention will become better understood with reference to the following detailed description and claims taken in conjunction with the accompanying drawing in which:

FIG. 1 depicts a perspective view of a leather awareness device in accordance with an exemplary embodiment of the present invention.

### DETAILED DESCRIPTION OF THE DRAWING

The present invention relates to an awareness ribbon made of leather that attaches to a keychain to be a continuous reminder of the cause for which the ribbon supports. The present invention provides a leather awareness device as a way to display support for a cause. The leather awareness device is a piece of leather shaped as an awareness ribbon. The awareness ribbon attaches to a key ring to enable the user to continuously carry the device wherever they go. The color and message displayed on the ribbon may be customized according to the affiliation preferred by the user. The leather awareness device afforded the user a unique and long lasting symbol which they may display proudly to show the cause they support.

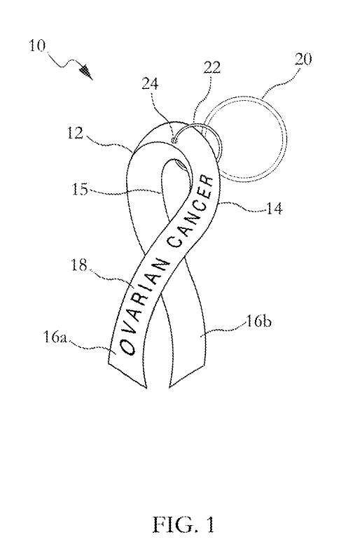

Turning now descriptively to the drawings, referring to FIG. 1, a leather awareness device 10 is shown in accordance with an exemplary embodiment of the present invention. The leather awareness device 10 comprises a looped structure 12 extending between a loop 14 and a pair of ends 16a, 16b. The looped structure 12 is shaped as a looped awareness ribbon, where the pair of ends 16a, 16b overlap and the loop 14 includes an inner opening 15. The looped structure 12 is made from leather which may be treated to be rigid or in a natural soft form. The leather of the looped structure 12 may be color treated to create colored permeated leather, or the leather may be painted over the top surface to provide rich vibrant coloring.

As illustrated in the figure, the first end 16a overlaps the second end 16b. The first end 16a may include a display portion 18. The display portion 18 may be a saying, logo, phrase, group, cause or the like to reflect the intentions of the leather awareness device 10. For example, the looped structure 12 may be colored yellow and the display portion 18 may reflect the words “SUPPORT OUR TROOPS”. Alternatively, the looped structure 12 may be painted as a rainbow puzzle and the display portion 18 may read “AUTISM AWARENESS”. The display portion 18 may be printed, painted, hand written, or even stamped into the leather. The top surface of the looped structure 12 may be sealed or treated to ensure that the markings of the display portion 18 are preserved. Because the same color may be used for different groups, the display portion 18 may be necessary to differentiate between the different causes and groups. This ensures that the user's preferred message is proudly displayed.

At a top of the loop 14 a fastener 20 is attached. The fastener 20 may include an accessory ring 22 which threads through a hole 24 within the loop 14. The fastener 20 may be a simple circular ring (as shown) that fastens to a set of keys. Alternatively, the fastener 20 may be a clip or carabiner for easily removable attachment to backpacks, purses, belt loops or other objects to which the user wishes to display their leather awareness device 10. The fastener 20 may be made from plastic or metal thereby providing a strong securing device for the looped structure 12.

The leather awareness device 10 may be handmade creating a unique symbol to display. The color may be hand painted with acrylic paints, and the leather may be hand stamped providing beautiful textures and lettering on the leather. With the leather awareness device 10 the user may personalize their ribbon to openly exhibit the causes they support.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. An awareness device to display support for a cause comprising:
a. a looped structure, where the looped structure extends between a loop and a first end and a second end, wherein said first end overlaps the second end, and where the looped structure is made from colored treated leather, where the loop includes an inner opening;
b. a display portion on a the first end, where the display portion represents a cause symbolized by the looped structure; and
c. a fastener attached to the loop, where the fastener enables removable attachment of the looped structure from an object.

2. (canceled)

3. The awareness device according to claim 1, where the colored leather of the looped structure is painted.

4. The awareness device according to claim 1, where the display portion includes a stamped marking.

5. The awareness device according to claim 1, where the display portion reflects one of at least a saying, phrase, cause, group, or logo.

6. The awareness device according to claim 1, where the fastener is a key ring.

7. The awareness device according to claim 1, where the fastener is a carabiner.

8. The awareness device according to claim 1, where the fastener is a clip.

9. The awareness device according to claim 1, where the looped structure is sealed for preservation.
